(19) United States
(12) Patent Application Publication
(10) Pub. No.: US 2001/0028873 A1
(43) Pub. Date: Oct. 11, 2001

(54) Process for the preparation of hydrogen peroxide

(76) Inventors: Thomas Haas, Frankfurt (DE); Jurgen Glenneberg, Offenbach (DE); Rudolf Wagner, Grosskrotzenburg (DE); Rudolf Vanheertum, Kahl (DE)

Correspondence Address: Pillsbury Winthrop LLP, Intellectual Property Group, Ninth Floor, 1100 New York Avenue, NW, Washington, DC, 20005-3918, US

(21) Appl. No.: 09/825,853

(22) Filed: Apr. 5, 2001

(30) Foreign Application Priority Data
Apr. 8, 2000 (DE) 100 17 656.9

(51) Int. Cl. C01B 15/023

(52) U.S. Cl. 423/588

(57) ABSTRACT

The invention relates to an improved process for the preparation of hydrogen peroxide by the anthraquinone process, the improvement being directed at decreasing epoxides in the oxidation stage. According to the invention, the hydrogenated working solution, comprising a 2-alkyl-tetrahydroanthrahydroquinone, is mixed with partly or, preferably, completely oxidized working solution and the mixture is oxidized with a gas comprising oxygen in an oxidation reactor. The volume ratio of hydrogenated to oxidized working solution is in the range from 5 to 1 to 1 to 5 and preferably in the range of 2 to 1 to 1 to 2.

### CROSS REFERENCE TO RELATED APPLICATIONS

The present application claims priority to German application 100 17 656.9 filed on Apr. 8, 2000, the subject matter of which is hereby incorporated by reference.

### FIELD OF THE INVENTION

The invention relates to a process for the preparation of hydrogen peroxide by the anthraquinone cyclic process comprising a hydrogenation stage, an oxidation stage and an extraction stage. By the process according to the invention it is possible largely to suppress the formation of anthraquinone epoxides in the oxidation stage.

### BACKGROUND OF THE INVENTION

A large-scale industrial process for the preparation of hydrogen peroxide is the so-called anthraquinone process. This process comprises a catalytic hydrogenation of a working solution comprising one or more anthraquinone derivatives, an oxidation stage in which the hydrogenated working solution is oxidized with an oxygen-containing gas and an extraction stage in which the hydrogen peroxide formed is extracted from the oxidized working solution with water or dilute hydrogen peroxide solution. After the phase separation, the organic working solution is recycled back to the hydrogenation stage. An overview of the chemistry and the industrial procedure of the anthraquinone process is given in Ullmann's Encyclopedia of Industrial Chemistry 5^{th} ed. (1989), vol. A13, 447-457.

The working solution comprises one or more solvents, the task of which is to dissolve both the anthraquinone derivatives serving as the reaction carriers and the anthrahydroquinone derivatives formed during the hydrogenation. The anthraquinone derivatives are, in particular, 2-alkylanthraquinones and tetrahydro derivatives thereof, 2-alkyl-5,6,7,8-tetrahydroanthraquinones. Both the alkyl-anthraquinones (abbreviated to alkyl-AQ in the following) and tetrahydro derivatives thereof (abbreviated to alkyl-THAQ in the following) participate in the cyclic process.

The oxidation stage and therefore the reaction stage in which the hydrogen peroxide is formed is of great importance for the overall process and the profitability of the process. Many processes are accordingly directed at carrying out the conversion of the 2-alkyl-anthrahydroquinones into the 2-alkyl-anthraquinones as quantitatively as possible, minimizing the reactor volume and the energy input and suppressing the formation of byproducts, such as the epoxide of the 2-alkyl-tetrahydroanthraquinone derivatives. This epoxide does not participate in the cyclic process itself, but must be converted back into active anthraquinone in an additional expensive regeneration stage.

In the process according to DE-OS 24 19 534, the formation of epoxides is minimized by oxidizing the hydrogenated working solution with pure oxygen or with air enriched with oxygen instead of with air. The use of oxygen or air enriched with oxygen causes not inconsiderable costs, but the formation of epoxide is also not suppressed to an adequate degree, so that a regeneration stage for the working solution, for example by contacting thereof with aluminium oxide at elevated temperature, continues to be necessary.

In the process according to EP 0 221 931 B1, the oxidation can be accelerated by passing a coalescence-inhibited system of the hydrogenated working solution and an oxidizing gas through a co-current reactor. The amount of by-products and degradation products indeed decreases in this process, but a device for regeneration of the working solution for the purpose of reducing the epoxide content cannot be dispensed with. Another oxidation process is the doctrine of DE 40 29 784 C2, in which the hydrogen-ated working solution and the oxidizing gas are mixed in a special device—in this process also the formation of epoxide cannot be reduced to an adequate degree.

### SUMMARY OF THE INVENTION

The object of the present invention is to improve the oxidation stage in the anthraquinone process to the extent that the epoxide of the tetrahydroanthraquinone derivative is formed in the oxidation stage to a considerably smaller extent than is the case in the processes already known. Preferably, substantially no epoxide should be formed. According to another object, it should be possible to integrate the process in a simple manner into an existing plant for the preparation of hydrogen peroxide by the anthraquinone process.

The objects mentioned and further objects such as can be seen from the description can be achieved by bringing the hydrogenated working solution into contact with a portion of the oxidized working solution and oxidizing the mixture substantially completely with a gas comprising oxygen, such as air.

The invention therefore provides a process for the preparation of hydrogen peroxide by the anthraquinone cyclic process, comprising (a) a catalytic hydrogenation of a working solution comprising a 2-alkyl-tetrahydroanthraquinone (A-THAQ), a hydrogenated working solution comprising 2-alkyl-tetrahydroanthrahydroquinone (A-THAHQ) being obtained, (b) an oxidation of the hydrogenated working solution with a gas comprising oxygen, an oxidized working solution comprising hydrogen peroxide and A-THAQ being obtained, and (c) an extraction of the hydrogen peroxide from dilute hydrogen peroxide solution. The process is characterized by the hydrogenated working solution being oxidized in a mixture with partly or completely oxidized working solution.

Preferably, before its entry into an oxidation reactor hydrogenated working solution is mixed with oxidized working solution in a volume ratio in the range from 5 to 1 to 1 to 1 and the mixture is oxidized in the oxidation reactor. As an alternative to this, it is also possible to feed hydrogenated and oxidized working solution separately to the oxidation reactor in the volume ratio mentioned, so that mixing takes place directly in this reactor, and in particular substantially in the first part thereof. According to a particularly preferred embodiment, hydrogenated and oxidized working solution are mixed in a volume ratio in the range from 2 to 1 to 1 to 2 before or at the start of the oxidation reactor and the mixture is oxidized.

### DETAILED DESCRIPTION OF THE INVENTION

The oxidation according to the invention of the mixture comprising hydrogenated and oxidized working solution can be carried out with air or another gas comprising oxygen, including pure oxygen. The pressure and temperature conditions of the oxidation stage substantially correspond to those such as are also used in the prior art. The reaction temperature is conventionally in the range from 30 to 70 ° C., in particular 45 to 60 ° C. The gas employed for the oxidation is conventionally fed to the oxidation reactor with a slight increased pressure, namely 0.1 to 0.5 MPa. According to a particularly preferred embodiment, air is used as the oxidation gas.

In the oxidation stage, the mixture of hydrogenated and oxidized working solution can be passed in co- or in counter-current through an oxidation reactor, conventionally one or more oxidation columns. Those oxidation reactors such as are known in the prior art can be used for the oxidation—reference is made by way of example to the embodiments according to the above-cited Ullmann's Encyclopedia of Industrial Chemistry and EP 0 221 931 B1. Another suitable embodiment of an oxidation column is that of the as yet unpublished DE Patent Application 198 43 573.8. This is a bubble column which can be operated in co-current or counter-current and has finely perforated trays, the cross-sectional area of the individual holes being 0.003 to 3 mm², in particular 0.05 to 0.5 mm² and the open area of the trays being 2 to 20%, in particular 3 to 7%. In the preferred procedure in counter-current, each finely perforated tray comprises a segment or tunnel-like element for passage of liquid into the zone lying underneath the tray.

The hydrogenated working solution to be fed to the oxidation stage can be obtained in any desired manner known in the art, it being possible for the hydrogenation of the working solution comprising at least one reaction carrier to be carried out employing a suspended catalyst or a fixed bed catalyst. The working solution to be hydrogenated comprises at least one 2-alkylanthraquinone and additionally the corresponding 2-alkyl-tetrahydroanthraquinone (A-THAQ). The A-THAQ can be already contained in the working solution or formed in the hydrogenation.

The process according to the invention is not tied to the use of a specific solvent or solvent mixture as a constituent of the working solution, but rather any of the solvents and solvent mixtures known to experts (see Ullmann's Encyclopedia) can be used.

According to a preferred embodiment of the anthraquinone process, the working solution to be fed to the hydrogenation stage comprises two different 2-alkylanthraquinones and at least the tetrahydro derivative of one of the two 2-alkylanthraquinones. It is particularly expedient to employ, in addition to 2-ethylanthraquinone, a 2-alkylanthraquinone having 4,5 or 6 C atoms in the alkyl group as a reaction carrier. The reaction carrier mixture additionally comprises the tetrahydro derivative of at least one of the two 2-alkylanthraquinones. The extraction of the hydrogen peroxide formed which follows the oxidation stage is carried out in any manner known in the art.

It was not foreseeable that by recycling a portion of the oxidized working solution and mixing this portion with hydrogenated working solution in the oxidation stage substantially none or only traces of the epoxide of the one or more 2-alkyl-tetrahydroanthraquinones is formed. On the basis of this surprising effect, the expenditure for the regeneration of the working solution can be reduced considerably.

The invention is illustrated further with the aid of the following examples.

### EXAMPLES

The experiments were carried out in a heated glass flask. The stirrer speed was about 1000 rpm. The volume of the glass flask was about 200 ml, and that of the working solution initially introduced 100 ml. Air was introduced into the solution under normal pressure. The working solution to be oxidized comprised a mixture of 70 vol % isodurol and 30 vol % trioctyl phosphate as the solvent and (a) 290 mmol or (b) 362 mmol tetrahydro-2-ethylanthrahydroquinone (THEAHQ) per kg working solution as the reaction carrier. The reaction temperature was 50° C. The stream of air was 50 Nl/h. The oxidized working solution was analysed for the epoxide content.

### Comparison Example 1

A working solution of composition (a) was oxidized: After a reaction time of 90 minutes the solution was completely oxidized. The content of 2-ethyl-tetrahydroanthraquinone epoxide (THEAQ epoxide) formed, based on the hydroquinone employed, was 0.32 mol %.

### Comparison Example 2

The THEAHQ concentration was 362 mmol/kg (corresponding to working solution (b)). After a reaction time of 80 min the THEAHQ was oxidized completely to THEAQ. The epoxide content formed was 0.5 mol %.

### Example 1

50 ml of the THEAHQ solution (=hydrogenated working solution (a)) were mixed with 50 ml of the reaction solution obtained in comparison example 1 (=oxidized working solution). This solution was oxidized for 80 min, the degree of oxidation was virtually complete. No additional formation of epoxide was to be detected within the measurement accuracy of 0.02 mol %.

### Example 2

65 ml of the THEAHQ solution (b) were mixed with 35 ml of the oxidized reaction solution obtained in Comparison Example 2. After 80 min the solution was oxidized completely. The epoxide content formed in the oxidation was 0.05 mol %.

### Example 3

50 ml of the THEAHQ solution (b) were mixed with 50 ml of the oxidized reaction solution obtained in Comparison Example 2. After 80 min the solution was oxidized completely. No additional formation of epoxide was to be detected within the measurement accuracy of 0.02 mol %.

### Example 4

35 ml of the THEAHQ solution (b) were mixed with 65 ml of the oxidized reaction solution obtained in Comparison Example 2. After 80 min the solution was oxidized completely. No additional formation of epoxide was to be detected within the measurement accuracy of 0.02 mol %.

What is claimed is:

1. A process for the preparation of hydrogen peroxide by the anthraquinone cyclic process, comprising:
(a) catalytic hydrogenation of a working solution comprising a 2-alkyl-tetrahydroanthraquinone (A-THAQ), to produce a hydrogenated working solution comprising 2-alkyl-tetrahydroanthrahydroquinone (A-THAHQ);
(b) oxidation of the hydrogenated working solution with a gas comprising oxygen, to produce an oxidized working solution comprising hydrogen peroxide and A-THAQ, wherein said hydrogenated working solution is oxidized as a mixture with partly or completely oxidized working solution;
(c) extraction of said hydrogen peroxide from said oxidized working solution.

2. The process according to claim 1, characterized in that, said oxidation takes place in a oxidation reactor, and before its entry into said oxidation reactor, said hydrogenated working solution is mixed with oxidized working solution in a volume ratio in the range from 5 to 1 to 1 to 5, or in that said hydrogenated and oxidized working solutions are fed separately to said oxidation reactor in said volume ratio and mixed therein.

3. The process according to claim 2, wherein said hydrogenated and oxidized working solutions are mixed in a volume ratio in the range from 2 to 1 to 1 to 2 before or in the oxidation reactor.

4. The process of any one of claims 1 to 3, wherein said oxidation is carried out employing air.

5. The process of any one of claims 1 to 4, characterized in that said oxidation occurs in a co- or counter-current bubble column with at least one finely perforated tray arranged horizontally in the central part and with a cross-sectional area of the individual holes of 0.003 to 3 mm² and an open area of the tray of 2 to 20%.
